(19) United States
(12) Patent Application Publication
(10) Pub. No.: US 2025/0333810 A1
(43) Pub. Date: Oct. 30, 2025

(54) COOLING APPARATUS FOR METAL STRIP, HEAT TREATMENT FACILITY FOR METAL STRIP, AND COOLING METHOD FOR METAL STRIP

(71) Applicant: PRIMETALS TECHNOLOGIES JAPAN, LTD., Hiroshima-shi, Hiroshima (JP)

(72) Inventors: Keiji MIZUTA, Hiroshima-shi (JP); Hirokazu KOSE, Hiroshima-shi (JP); Takanori NAGAI, Hiroshima-shi (JP)

(73) Assignee: PRIMETALS TECHNOLOGIES JAPAN, LTD., Hiroshima-shi, Hiroshima (JP)

(21) Appl. No.: 18/864,373

(22) PCT Filed: Jun. 22, 2022
(86) PCT No.: PCT/JP2022/024953

§ 371 Date: Nov. 8, 2024

(51) Int. Cl. C21D 1/667; C21D 9/00; C21D 9/56

(52) U.S. Cl. CPC C21D 1/667; C21D 9/0062; C21D 9/56

(57) ABSTRACT

A cooling apparatus for a metal strip is a cooling apparatus for cooling a traveling metal strip, including a plurality of nozzles each of which is configured to spray a cooling medium to a surface of the metal strip. A ratio La/Ln of a length La of an ineffective collision region between a pair of effective collision regions adjacent in a traveling direction of the metal strip among effective collision regions of the plurality of nozzles in the traveling direction to a center-to-center distance Ln of the pair of effective collision regions in the traveling direction is at least 0.2 and at most 0.6. The effective collision regions are regions in which a collision density of a liquid on the surface of the metal strip is at least 50% of a maximum value, the liquid being contained in the cooling medium sprayed from the nozzles to the surface.

### TECHNICAL FIELD

The present disclosure relates to a cooling apparatus for a metal strip, a heat treatment facility for the metal strip, and a cooling method for the metal strip.

### BACKGROUND

In a process of producing a metal strip, a metal strip after heating may rapidly be cooled in order to, for example, obtain a metal strip having a desired property.

Patent Document 1 discloses continuous production lines for metal strips, which comprises rapid cooling sections including nozzles for spraying a liquid or a mixture of gas and liquid. In the continuous production lines for metal strips, the strip is cooled at a speed between 400° C./s and 1200° C./s by spraying the above-described liquid or mixture to the strip from the nozzles in the rapid cooling sections.

### CITATION LIST

### Patent Literature

Patent Document 1: JP2020-513480A (translation of a PCT application)

### SUMMARY

### Technical Problem

In a process of producing a metal strip, it is desirable to efficiently cool the metal strip, for example, during rapid cooling of the metal strip.

In view of the above, an object of at least one embodiment of the present invention is to provide a cooling apparatus for a metal strip, a heat treatment facility for the metal strip, and a cooling method for the metal strip, which are capable of efficiently cooling the metal strip.

### Solution to Problem

A cooling apparatus for a metal strip according to at least one embodiment of the present invention is a cooling apparatus for cooling a traveling metal strip, including: a plurality of nozzles each configured to spray a cooling medium to a surface of the metal strip. A ratio La/Ln of a length La of an ineffective collision region between a pair of effective collision regions adjacent in a traveling direction of the metal strip among effective collision regions of the plurality of nozzles in the traveling direction to a center-to-center distance Ln of the pair of effective collision regions in the traveling direction is at least 0.2 and at most 0.6. The effective collision regions are regions in which a collision density of a liquid on the surface of the metal strip is at least 50% of a maximum value, the liquid being contained in the cooling medium sprayed from the nozzles to the surface.

Further, a heat treatment facility according to at least one embodiment of the present invention, includes: a furnace for heat treating the metal strip; and the above-described cooling apparatus configured to cool the metal strip heat treated in the furnace.

Furthermore, a cooling method for a metal strip according to at least one embodiment of the present invention is a cooling method for cooling a traveling metal strip by using a cooling apparatus including a plurality of nozzles, including: a step of cooling the metal strip by spraying a cooling medium to a surface of the metal strip from the plurality of nozzles. The step of cooling includes spraying the cooling medium to the surface of the metal strip such that a ratio La/Ln of a length La of an ineffective collision region between a pair of effective collision regions adjacent in a traveling direction of the metal strip among effective collision regions of the plurality of nozzles in the traveling direction to a center-to-center distance Ln of the pair of effective collision regions in the traveling direction is at least 0.2 and at most 0.6. The effective collision regions are regions in which a collision density of a liquid on the surface of the metal strip is at least 50% of a maximum value, the liquid being contained in the cooling medium sprayed from the nozzles to the surface.

### Advantageous Effects

According to at least one embodiment of the present invention, provided are a cooling apparatus for a metal strip, a heat treatment facility for the metal strip, and a cooling method for the metal strip, which are capable of efficiently cooling the metal strip.

### BRIEF DESCRIPTION OF DRAWINGS

FIG. 1 is a schematic configuration view of a heat treatment facility for a metal strip, to which a cooling apparatus is applied, according to an embodiment.

FIG. 2 is a schematic view of the cooling apparatus viewed from a thickness direction of the metal strip according to an embodiment.

FIG. 3 is a schematic view for describing an effective injection region of a nozzle.

FIG. 4 is a view for describing a configuration of the cooling apparatus according to an embodiment.

FIG. 5 is a view for describing the configuration of the cooling apparatus according to an embodiment.

FIG. 6 is a graph showing a relationship between a ratio La/Ln and a heat transfer coefficient between a cooling medium sprayed to the metal strip.

FIG. 7 is a graph showing a relationship between a length Le of an effective collision region and the heat transfer coefficient between the cooling medium sprayed to the metal strip.

FIG. 8 is a view of a surface of the metal strip, which is cooled by the cooling apparatus, viewed from a strip thickness direction according to an embodiment.

FIG. 9 is a view of the surface of the metal strip, which is cooled by the cooling apparatus, viewed from the strip thickness direction according to an embodiment.

FIG. 10 is a view of the surface of the metal strip, which is cooled by the cooling apparatus, viewed from the strip thickness direction according to an embodiment.

FIG. 11 is a view schematically showing a plurality of effective collision regions Re aligned in a width direction of the metal strip.

FIG. 12 is a view schematically showing the plurality of effective collision regions Re aligned in the width direction of the metal strip.

FIG. 13 is a graph showing an example of a time change in temperature of a specific portion of the metal strip during heat treatment.

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

### (Configuration of Heat Treatment Facility)

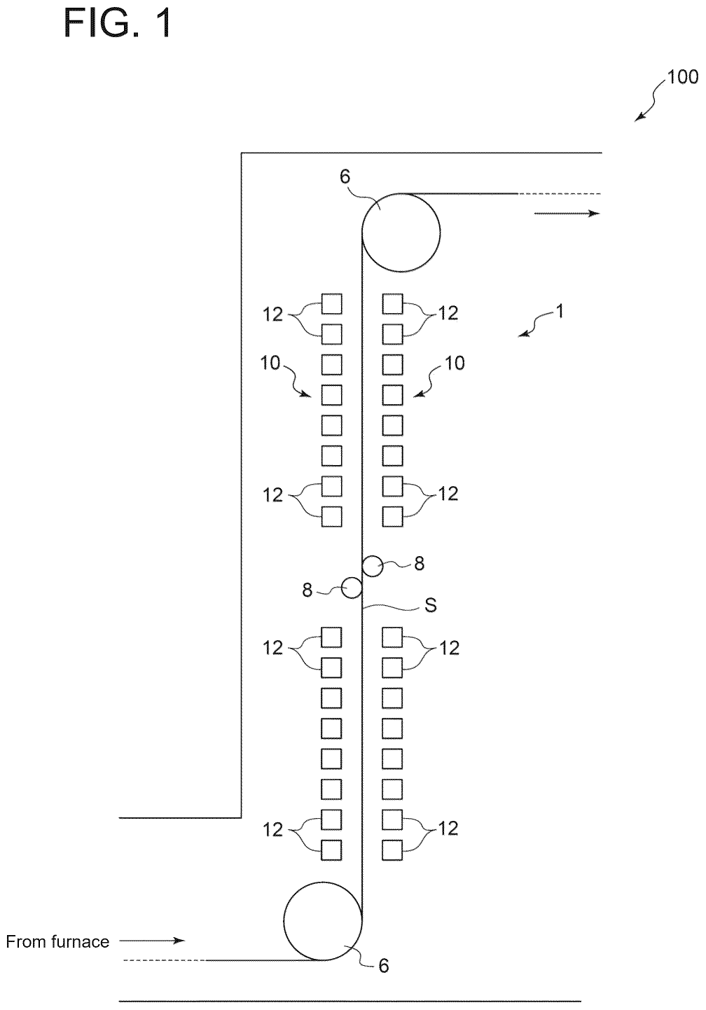

FIG. 1 is a schematic configuration view of a heat treatment facility for a metal strip, to which a cooling apparatus is applied, according to an embodiment. As shown in the drawing, a heat treatment facility 100 includes a first furnace (not shown) for heating a metal strip S (such as a steel strip), rolls 6 for conveying the metal strip S, and a cooling apparatus 1 for cooling the metal strip S heated in the first furnace described above. That is, the cooling apparatus 1 may be disposed downstream of the first furnace in a conveying direction of the metal strip S. Arrows in FIG. 1 represent the conveying direction (traveling direction, moving direction) of the metal strip S.

In the exemplary embodiment shown in FIG. 1, the metal strip S is conveyed in an up-down direction (from bottom toward top in the illustrated example) between the rolls 6 and 6 installed apart in the up-down direction. Between the rolls 6 and 6, a pair of guide rolls 8 and 8 are disposed so as to sandwich the metal strip S, thereby suppressing deflection or twisting of the metal strip S.

The cooling apparatus 1 is configured to cool a traveling metal strip. The cooling apparatus 1 includes a pair of jet units 10 and 10 disposed on both sides of a pass line of the metal strip S in a thickness direction of the metal strip S (strip thickness direction). The pair of jet units 10 and 10 are configured to jet a cooling medium toward a surface of the metal strip S. By thus spraying the cooling medium from the jet units 10 and 10 toward the surface of the metal strip S, the metal strip S can effectively be cooled.

Although not specifically illustrated, in some embodiments, the cooling apparatus 1 may be configured to cool the metal strip S conveyed (traveling) along a top-to-bottom direction or the horizontal direction. In this case, the cooling apparatus 1 may include a jet unit disposed on at least one of the both sides of the metal strip S in the thickness direction (i.e., the up-down direction).

The heat treatment facility 100 may include a second furnace (not shown; i.e., a furnace disposed downstream of the cooling apparatus 1 in the conveying direction of the metal strip S) for reheating the metal strip S cooled by the cooling apparatus 1.

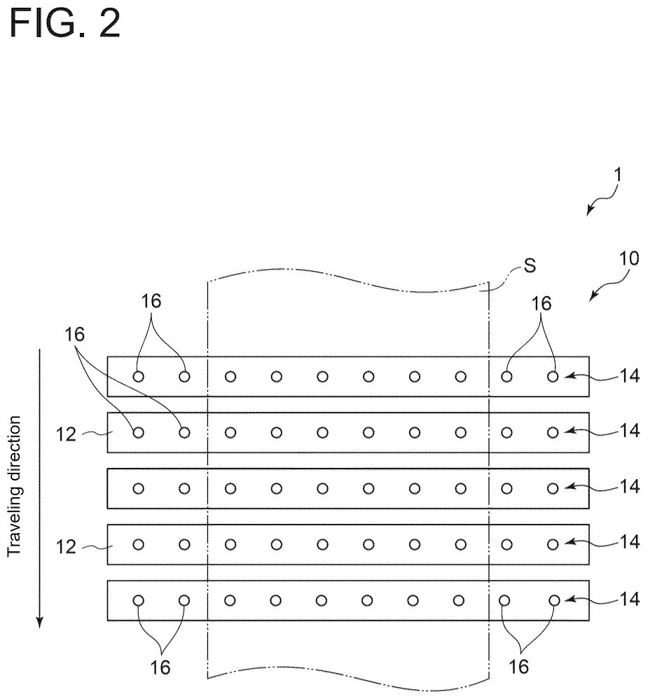

FIG. 2 is a schematic view of the cooling apparatus 1 viewed from the thickness direction of the metal strip S according to an embodiment. As shown in FIG. 2, the jet unit 10 includes a plurality of nozzles 16 each configured to spray the cooling medium toward the surface of the metal strip S. The plurality of nozzles 16 constitute a plurality of nozzle rows 14 arranged along the traveling direction (conveying direction) of the metal strip S. Each of the plurality of nozzle rows 14 is constituted by the plurality of nozzles 16 arranged along a width direction of the metal strip S. The cooling medium may be water or a liquid containing water as a main component, or a mixture of them and gas.

Each of the plurality of nozzle rows 14 may be disposed in a header portion 12 configured to be supplied with the cooling medium. The header portion 12 communicates with the plurality of nozzles 16 disposed in the header portion 12, and the cooling medium supplied to the header portion is sprayed toward the surface of the metal strip S by the plurality of nozzles 16. As shown in FIGS. 1 and 2, the plurality of header portions 12 each extending in the width direction of the metal strip S may be arranged along the traveling direction of the metal strip S. The header portion 12 may have a box shape extending along the width direction of the metal strip S.

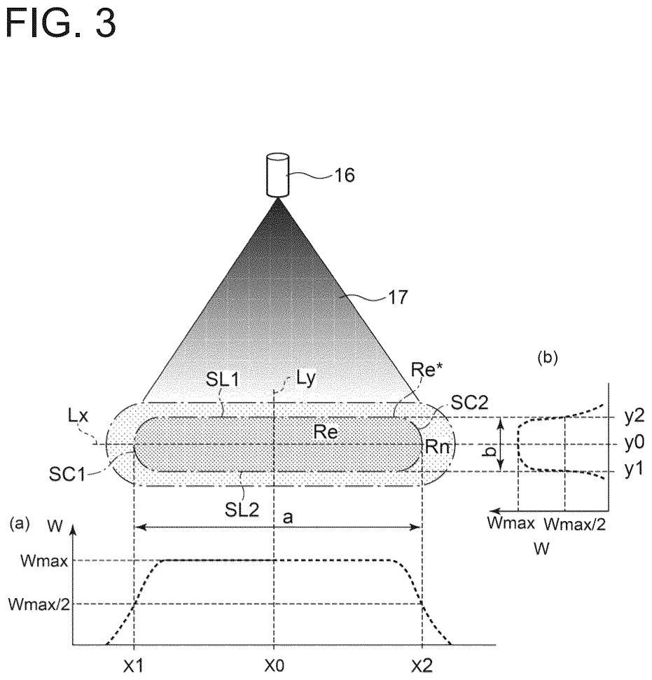

Herein, with reference to FIG. 3, an effective collision region of the nozzle 16 will be described. FIG. 3 is a schematic view for describing an effective injection region of the nozzle 16. FIG. 3 schematically shows a cooling medium 17 sprayed from the nozzle 16, and a collision region R0 and an effective collision region Re, which are regions on the surface of the metal strip S, with which a liquid contained in the cooling medium 17 collides. FIG. 3 shows the collision region R0 and the effective collision region Re when the surface of the metal strip S is viewed in plan view.

Graph (a) in FIG. 3 is a graph showing a relationship between a position on the x-axis (straight line Lx) extending in a first direction (a direction indicated by arrow a) on the surface of the metal strip S and a collision density (an amount of the liquid supplied per unit time, per unit area) W on the surface of the liquid contained in the cooling medium sprayed from the certain nozzle 16. Graph (b) in FIG. 3 is a graph showing a relationship between a position on the y-axis (straight line Ly) extending in a second direction (a direction indicated by arrow b) orthogonal to the first direction on the surface of the metal strip S and the collision density W on the surface of the liquid contained in the cooling medium sprayed from the above-described nozzle 16. The x-axis and the y-axis intersect at the center of the collision region R0 (the center of the effective collision region Re).

In the present specification, the effective collision region Re (see FIG. 3) of the nozzle 16 is a region of the collision region R0 (see FIG. 3) in which the liquid contained in the cooling medium 17 sprayed from the nozzle 16 to the surface of the metal strip S collides with the surface of the metal strip S, in which the collision density W on the surface of the liquid contained in the cooling medium 17 sprayed from the nozzle 16 to the surface of the metal strip S is at least 50% of a maximum value.

In the example shown in FIG. 3, on the x-axis (straight line Lx), the collision density W has a maximum value Wmax at a center position x0 of the collision region R0, and the collision density Wis 50% of the maximum value (Wmax/2) at positions x1 and x2 in both end portions. On the y-axis (straight line Ly), the collision density W has the maximum value Wmax at a center position y0 of the collision region R0, and the collision density W is 50% of the maximum value (Wmax/2) at positions y1 and y2 in both end portions. Then, a region surrounded by a contour Re*, which includes a region between x1 and x2 on the x-axis and a region from y1 to y2 on the y-axis, is the effective collision region Re.

In the example shown in FIG. 3, the contour Re* of the effective collision region Re has a shape in which a pair of semicircular arcs (SC1 and SC2) are connected by two straight lines (SL1 and SL2) parallel to each other. Further, a length of the effective collision region Re in the first direction is a, and a length in the second direction is b.

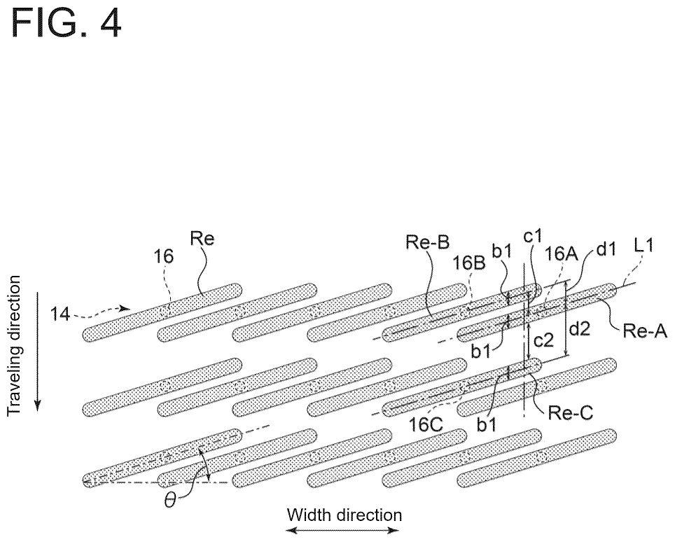

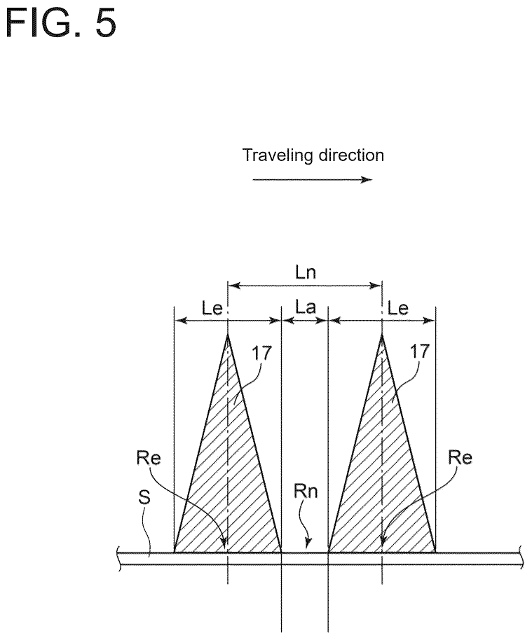

FIGS. 4 and 5 are each a view for describing a configuration of the cooling apparatus 1 according to an embodiment. FIG. 4 is a schematic view showing an example of the plurality of effective collision regions Re respectively formed on the surface of the metal strip S by the plurality of nozzles 16 configuring the cooling apparatus 1. FIG. 5 is a view schematically showing a pair of effective collision regions Re adjacent in the traveling direction of the metal strip S, and a pair of cooling media 17 forming the pair of effective collision regions Re.

As shown in FIG. 4, the plurality of effective collision regions Re are formed on the surface of the metal strip S by the plurality of nozzles 16. The arrangement of the plurality of effective collision regions Re has a shape corresponding to the arrangement of the plurality of nozzles 16 (indicated by dashed lines). The plurality of effective collision regions Re shown in FIG. 4 have the same shape as each other. Each of the plurality of effective collision regions Re shown in FIG. 4 has a shape extending along a straight line L1 in the figure. The straight line L1 is inclined with respect to the width direction of the metal strip S. An inclination angle of the straight line L1 with respect to the width direction is 0.

As shown in FIG. 5, among the effective collision regions Re of the plurality of nozzles 16 (see FIG. 4), an ineffective collision region Rn is formed between a pair of effective collision regions Re adjacent in the traveling direction of the metal strip S.

In a typical embodiment, for example, as shown in FIG. 4, a pair of effective collision regions Re adjacent in the traveling direction of the metal strip S have the same shape, but a pair of adjacent effective collision regions Re may have different shapes from each other.

In some embodiments, a ratio La/Ln of a length La of the ineffective collision region Rn between a pair of effective collision regions Re adjacent in the traveling direction of the metal strip S in the traveling direction to a center-to-center distance Ln of the pair of effective collision regions Re in the traveling direction is at least 0.2 and at most 0.6.

A pair of effective collision regions Re adjacent in the traveling direction of the metal strip S may be the effective collision regions Re (for example, effective collision regions Re-A and Re-B in FIG. 4) of a pair of nozzles 16 and 16 (for example, nozzles 16A and 16B in FIG. 4) included in the same nozzle row 14. In FIG. 4, the center-to-center distance Ln of the above-described pair of effective collision regions Re-A and Re-B in the traveling direction of the metal strip S is d1, and the length La of the ineffective collision region Rn between the pair of effective collision regions Re-A and Re-B in the traveling direction of the metal strip Sis c1.

Alternatively, a pair of effective collision regions Re adjacent in the traveling direction of the metal strip S may be the effective collision regions Re (for example, effective collision regions Re-A and Re-C in FIG. 4) of a pair of nozzles 16 and 16 (for example, nozzles 16A and 16C in FIG. 4) respectively included in the nozzle rows 14 and 14 adjacent in the traveling direction of the metal strip S. In FIG. 4, the center-to-center distance Ln of the above-described pair of effective collision regions Re-A and Re-C in the traveling direction of the metal strip S is d2, and the length La of the ineffective collision region Rn between the pair of effective collision regions Re-A and Re-C in the traveling direction of the metal strip Sis c2.

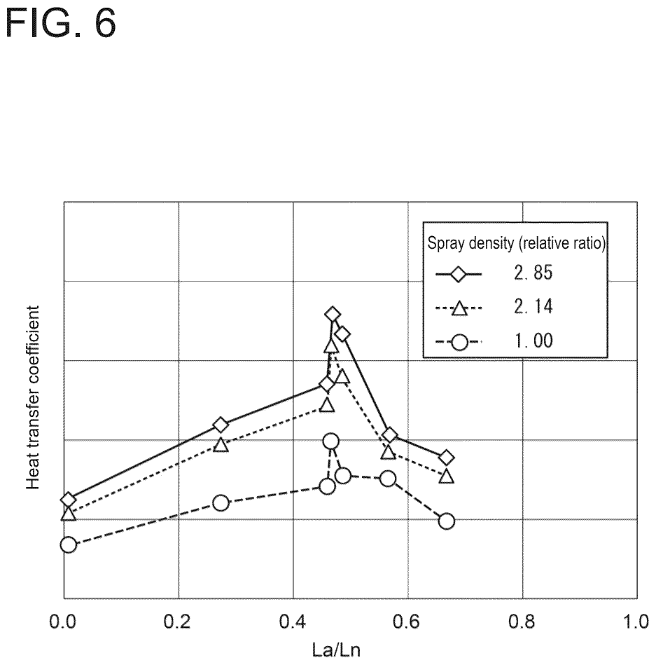

Herein, FIG. 6 is a graph showing a relationship between the above-described ratio La/Ln (horizontal axis) and a heat transfer coefficient (vertical axis) between the cooling medium sprayed to the metal strip S. The heat transfer coefficient in the graph is measurement results of the heat transfer coefficient when water is sprayed to the metal strip S of 400° C. to cool the metal strip S. These measurement results of the heat transfer coefficient are acquired while changing the above-described ratio La/Ln and while changing the collision density of the liquid contained in the cooling medium on the surface of the metal strip S.

As can be seen from the graph of FIG. 6, the above-described heat transfer coefficient is high when the above-described ratio La/Ln is at least 0.2 and at most 0.6. That is, when the above-described ratio La/Ln is at least 0.2 and at most 0.6, cooling efficiency of the metal strip S by the cooling medium sprayed from the nozzle 16 of the cooling apparatus 1 is high. Reasons therefor are considered to be as follows.

That is, in the above-described embodiment, since the above-described ratio La/Ln is at least 0.2, a dimension of the ineffective collision region Rn formed between the effective collision regions Re in the traveling direction of the metal strip S can be secured to some extent. Therefore, the liquid contained in the cooling medium jetted from the nozzle 16 and colliding with the surface of the metal strip S can leave the surface of the metal strip S via the ineffective collision region Rn without staying in the effective collision region Re. Whereby, it is difficult to impede the supply of the cooling medium newly jetted from the nozzle 16 to the surface of the metal strip S, improving the cooling efficiency. Further, in the above-described embodiment, since the above-described ratio La/Ln is at most 0.6, in the traveling direction of the metal strip S, the ineffective collision region Rn that does not contribute to cooling of the metal strip S is not too wide. Therefore, the dimensions of the effective collision regions Re in the traveling direction of the metal strip S can be maintained, improving the cooling efficiency. Thus, according to the above-described embodiment, the metal strip S can efficiently be cooled.

In some embodiments, the above-described ratio La/Ln is at least 0.45 and at most 0.5.

As can be seen from the graph of FIG. 6, the above-described heat transfer coefficient is particularly high when the above-described ratio La/Ln is at least 0.45 and at most 0.5. That is, when the above-described ratio La/Ln is at least 0.45 and at most 0.5, the cooling efficiency of the metal strip S by the cooling medium sprayed from the nozzle 16 of the cooling apparatus 1 is particularly high.

That is, in the above-described embodiment, since the above-described ratio La/Ln is at least 0.45, the greater dimension of the ineffective collision region Rn formed between the effective collision regions Re can be secured. Therefore, as described above, it is more difficult to impede the supply of the cooling medium newly jetted from the nozzle 16 to the surface of the metal strip S, further improving the cooling efficiency. Further, in the above-described embodiment, since the above-described ratio La/Ln is at most 0.5, the ineffective collision region Rn that does not contribute to cooling of the metal strip S can be made narrower. Therefore, the effective collision regions Re can be made wider, further improving the cooling efficiency. Thus, according to the above-described embodiment, the metal strip S can more efficiently be cooled.

In some embodiments, the length Le of each of a pair of effective collision regions Re described above in the traveling direction of the metal strip S is not less than 80 mm and not greater than 140 mm.

The length Le of each of a pair of effective collision regions Re-A and Re-B in FIG. 4 in the traveling direction of the metal strip S is b1. The length Le of each of a pair of effective collision regions Re-A and Re-C in FIG. 4 in the traveling direction of the metal strip S is also b1.

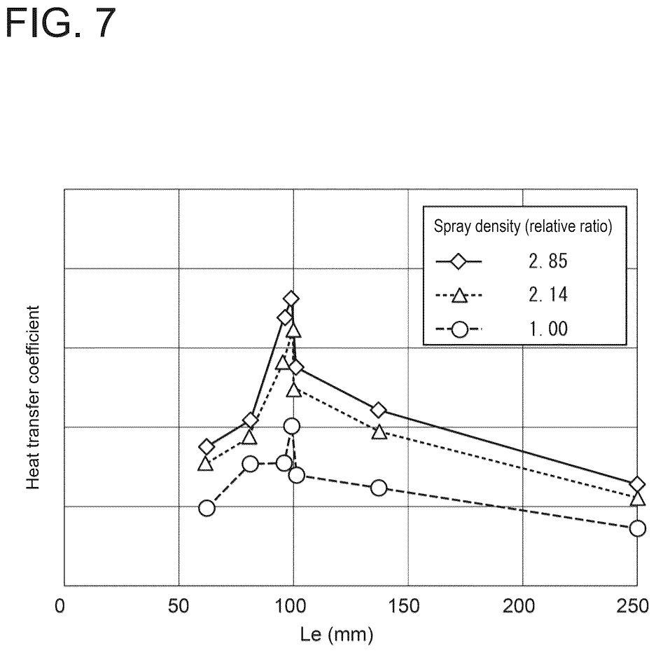

Herein, FIG. 7 is a graph showing a relationship between the length Le (horizontal axis) of the effective collision region Re in the traveling direction of the metal strip S and the heat transfer coefficient (vertical axis) between the cooling medium sprayed to the metal strip S. The heat transfer coefficient in the graph is measurement results of the heat transfer coefficient when water is sprayed to the metal strip S of 400° C. to cool the metal strip S. These measurement results of the heat transfer coefficient are acquired while changing the above-described length Le and while changing the collision density of the liquid contained in the cooling medium on the surface of the metal strip S.

As can be seen from the graph of FIG. 7, the above-described heat transfer coefficient is high when the above-described length Le is not less than 80 mm and not greater than 140 mm. That is, when the above-described length Le is not less than 80 mm and not greater than 140 mm, the cooling efficiency of the metal strip S by the cooling medium sprayed from the nozzle 16 of the cooling apparatus 1 is high. Reasons therefor are considered to be as follows.

That is, in the above-described embodiment, since the length Le of the effective collision region Re of the nozzle 16 is not less than 80 mm, it takes a certain amount of time for the metal strip S to pass through the effective collision region Re. Therefore, while the metal strip S passes through the effective collision region Re, a surface temperature of the metal strip S is likely to enter a transition boiling region from a film boiling region. Thus, the metal strip S can more efficiently be cooled. Further, in the above-described embodiment, since the length Le of the effective collision region Re of the nozzle 16 is not greater than 140 mm, a moving distance of a liquid film formed within the effective collision region Re to the ineffective collision region Rn is relatively short. Therefore, the liquid film formed within the effective collision region Re easily flows out to the ineffective collision region Rn, and can smoothly leave the surface of the metal strip S via the ineffective collision region Rn. Whereby, it is difficult to impede the supply of the cooling medium newly jetted from the nozzle 16 to the surface of the metal strip S, further improving the cooling efficiency. Thus, according to the above-described embodiment, the metal strip can more efficiently be cooled.

When the surface temperature of the metal strip S enters the transition boiling region from the film boiling region during cooling in the one effective collision region Re, a heat flux from the surface of the metal strip S to the liquid rises rapidly and the temperature is likely to be maintained at the temperature of the transition boiling region until the next effective collision region Re is entered, and thus the temperature of the metal strip S decreases smoothly. In contrast, if cooling progresses only to a point just before entering the transition boiling region from the film boiling region during cooling in the one effective collision region Re, the surface temperature of the metal strip S recovers (rises), and when the next effective collision region Re is entered, cooling begins again from the film boiling region, decreasing the cooling efficiency. In this respect, as described above, it is advantageous for the length of the effective collision region Re to be relatively long.

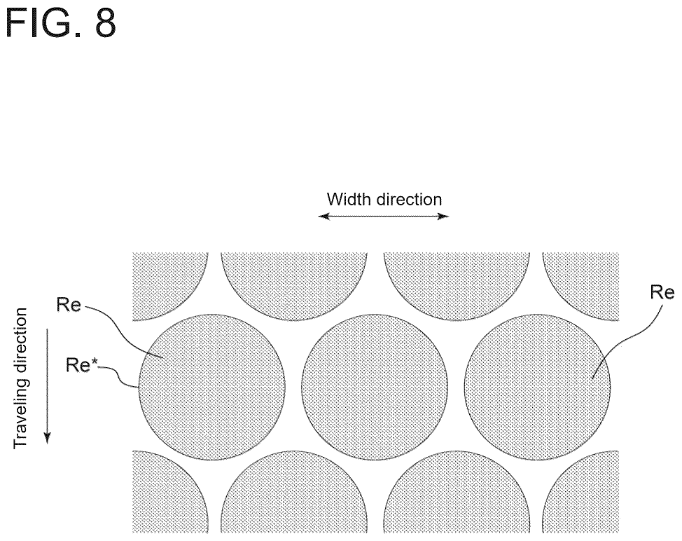

FIGS. 8 to 10 are each a view of the surface of the metal strip S, which is cooled by the cooling apparatus 1, viewed from the strip thickness direction according to an embodiment, and is a view schematically showing the effective collision region Re of the nozzle 16 of the cooling apparatus 1. In the examples shown in FIGS. 8 to 10, the effective collision region Re exists for each of the plurality of nozzles 16, and the arrangement of the plurality of effective collision regions Re has a shape corresponding to the arrangement of the plurality of nozzles 16.

In some embodiments, for example, as shown in FIG. 8, the effective collision region Re of the nozzle 16 is circular. That is, the contour Re* of the effective collision region Re has an arc shape.

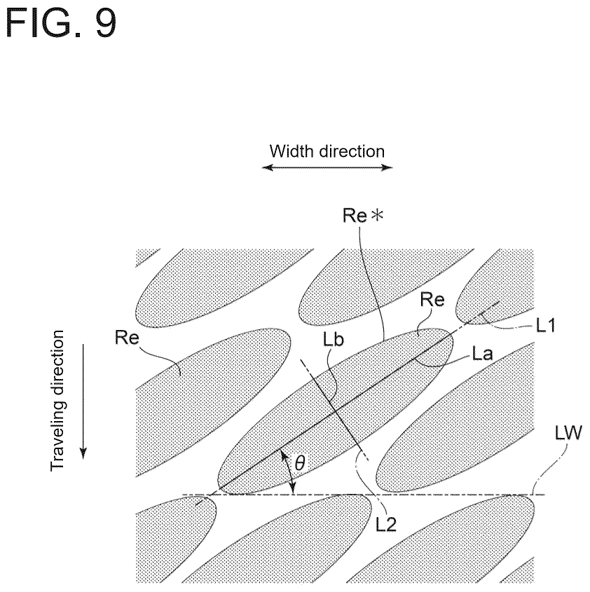

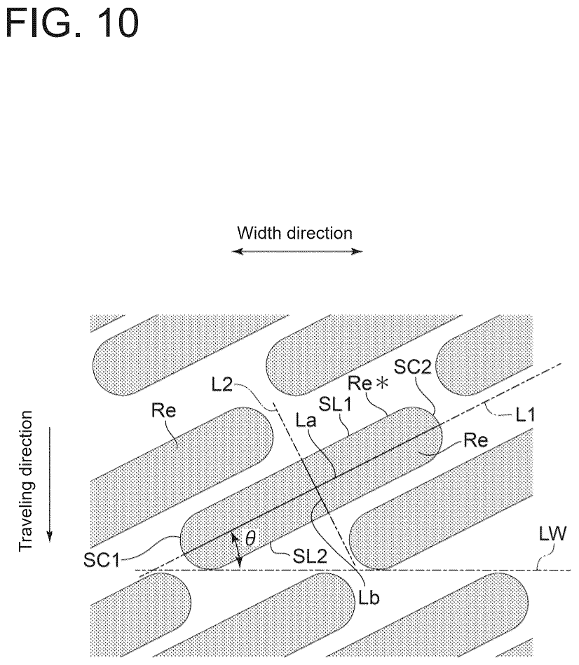

In some embodiments, each of the plurality of effective collision regions Re shown in FIGS. 9 and 10 has a shape extending in a direction (a direction of the straight line L1) along the width direction of the metal strip S.

In some embodiments, for example, as shown in FIGS. 9 and 10, the effective collision region Re of the nozzle 16 has a shape having a first axis La extending along the width direction of the metal strip S (or extending in the direction of the straight line L1) and a second axis Lb extending in a direction intersecting the first axis La, and the length of the first axis La is longer than the length of the second axis Lb. The first axis La is along the width direction of the metal strip S means that the angle θ of the first axis La with respect to the width direction (indicated by a straight line LW) is less than 45 degrees. In the exemplary embodiments shown in FIGS. 9 and 10, the first axis La and the second axis Lb, which are described above, are orthogonal to each other.

In the above-described embodiment, since the effective collision region Re has the shape having the first axis La along the width direction of the metal strip S and the second axis Lb intersecting the first axis La, and the first axis La is longer than the second axis Lb, the length of the effective collision region Re in the traveling direction of the metal strip S (the direction intersecting the width direction) is unlikely to become excessively long. Therefore, the liquid contained in the cooling medium sprayed from the nozzle 16 easily moves from the effective collision region Re to the ineffective collision region Rn (see FIG. 3) and smoothly leaves the surface of the metal strip S via the ineffective collision region Rn without staying in the effective collision region Re. Whereby, it is difficult to impede the supply of the cooling medium newly jetted from the nozzle 16 to the surface of the metal strip S, further improving the cooling efficiency.

In some embodiments, the above-described first axis La is inclined with respect to the width direction of the metal strip S. That is, in some embodiments, the angle θ (see FIG. 9 or FIG. 10) of the first axis La with respect to the width direction of the metal strip S (the direction of the straight line LW) is greater than 0.

In this case, focusing on a specific position in the width direction, the proportion of a region in which the effective collision region Re exists can be increased in the traveling direction of the metal strip S compared to when the first axis La is not inclined with respect to the width direction of the metal strip S (that is, when the first axis La is parallel to the width direction). Therefore, uneven cooling in the traveling direction of the metal strip S can be suppressed, thereby facilitating the production of the metal strip S of good quality.

In some embodiments, the above-described angle θ is not greater than 18 degrees.

In the above-described embodiment, since the above-described angle θ is not greater than 18 degrees, a timing at which the metal strip S entering the effective collision region Re is cooled does not vary significantly depending on the position in the width direction. Therefore, it is possible to reduce a difference in timing at which the surface temperature of the metal strip S in the strip width direction reaches a transition boiling temperature. Accordingly, it is possible to more effectively suppress uneven cooling in the width direction of the metal strip S.

In some embodiments, the above-described angle θ is not less than 5 degrees and not greater than 15 degrees.

In the above-described embodiment, since the above-described angle θ is not less than 5 degrees and not greater than 15 degrees, it is possible to further effectively suppress uneven cooling in the traveling direction and the width direction of the metal strip S. Therefore, it is easier to produce the metal strip of good quality.

In some embodiments, for example, as shown in FIG. 9, the effective collision region Re of the nozzle 16 has an elliptical shape with the first axis La along the width direction of the metal strip S as the major axis and the second axis Lb orthogonal to the first axis La as the minor axis.

In some embodiments, for example, as shown in FIG. 10, the contour Re* of the effective collision region Re the contour of the effective collision region of the nozzle 16 has the shape in which a pair of semicircular arcs SC1 and SC2 are connected by the two straight lines SL1 and SL2. In the exemplary embodiment shown in FIG. 10, a pair of semicircular arcs SC1 and SC2 have the same radius, and the two straight lines SL1 and SL2 are parallel to each other. Hereinafter, for example, as shown in FIG. 10, a shape formed by a pair of semicircular arcs and the two parallel straight lines connecting the semicircular arcs is called an oval shape for convenience.

In the above-described embodiment, since the contour Re* of the effective collision region Re has the shape in which a pair of semicircular arcs SC1 and SC2 are connected by the two straight lines SL1 and SL2, it is possible to widen a region in which an integrated value of a spray amount of the cooling medium over an entire length of the metal strip S in the traveling direction is uniform in the width direction. Accordingly, it is possible to more effectively reduce uneven cooling in the width direction of the metal strip S.

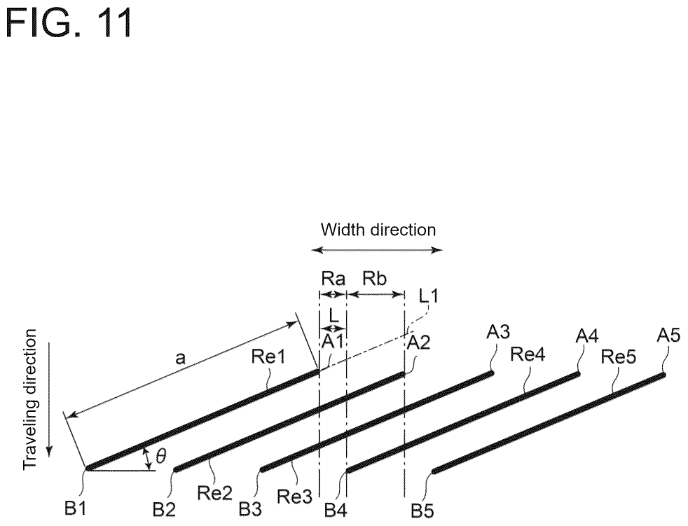

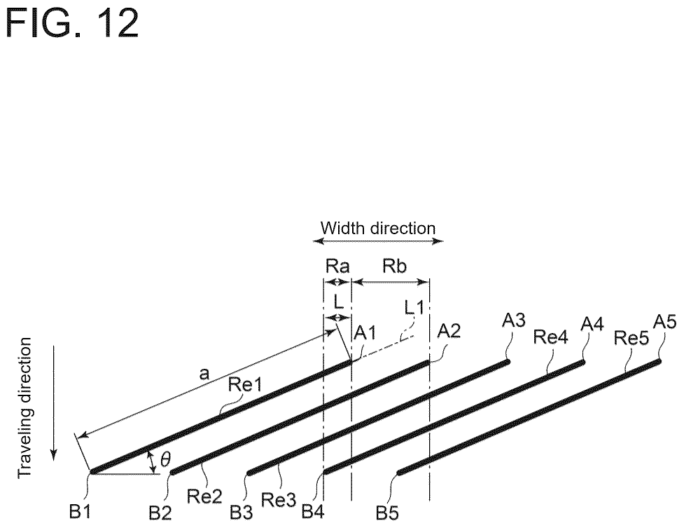

FIGS. 11 and 12 are each a view schematically showing the plurality of effective collision regions Re (Re1 to Re5) aligned in the width direction of the metal strip S. Each of these effective collision regions Re has an oval shape (see FIG. 10). In the examples shown in FIGS. 11 and 12, each of the plurality of effective collision regions Re1 to Re5 extends along the width direction of the metal strip S, and has a length (a length of the major axis) of a. Further, an angle of an extension direction (a direction of the major axis; a direction indicated by the straight line L1) of the plurality of effective collision regions Re1 to Re5 to the width direction of the metal strip S is 0 (note that 0 degrees<θ<45 degrees). Furthermore, the major axes of the plurality of effective collision regions Re1 to Re5 have end points A1 to A5 on one side in the width direction of the metal strip S and end points B1 to B5 on another side in the width direction of the metal strip S, respectively.

In some embodiments, among the plurality of effective collision regions aligned in the width direction of the metal strip S, a distance L in the width direction of the metal strip S between the end point A of the one effective collision region Re (for example, Re1 in FIGS. 11 and 12) and the end point B (B4 in FIGS. 11 and 12) of another effective collision region Re (the effective collision region Re4 in FIGS. 11 and 12) having the end point B closest to the end point A (A1 in FIGS. 11 and 12) of the one effective collision region Re in the width direction of the metal strip S, the length a of the major axis of the effective collision region Re, and the angle θ of the major axis with respect to the width direction has a relation of the following expression (a).

$$- 0.1 \leq L / ( a \times cos ( θ ) ) \leq 0.1 \qquad ( a )$$

In the width direction of the metal strip S, the number of effective collision regions passed by the metal strip S when the metal strip S travels a length (a×sin(θ)) of the effective collision region Re differs between a section Ra between the end point A of the one effective collision regions Re (such as the end point A1 of the effective collision region Re1) described above and the end point B of the another effective collision region Re (such as the end point B4 of the effective collision region Re4) described above and another section Rb.

For example, in FIG. 11, when the metal strip S travels the length (a×sin(θ) of the effective collision region Re, the metal strip S passes through two effective collision regions Re in the section Ra, whereas the metal strip S passes through three effective collision regions Re in the section Rb. Further, for example, in FIG. 12, when the metal strip S travels the length (a×sin(θ)) of the effective collision region Re, the metal strip S passes through four effective collision regions Re in the section Ra, whereas the metal strip S passes through three effective collision regions Re in the section Rb.

Therefore, if the length (L) of the section Ra other than the section Rb occupying a majority of the strip width direction is shorter than the length (a×cos(θ)) of the effective collision region Re in the strip width direction, it is easier to suppress uneven temperature in the strip width direction after passing through the effective collision region Re. Thus, uneven cooling of the metal strip S after cooling can more effectively be suppressed by causing the distance L, the length a of the major axis of the effective collision region Re, and the angle θ of the major axis with respect to the width direction, which are described above, to satisfy the above expression (a).

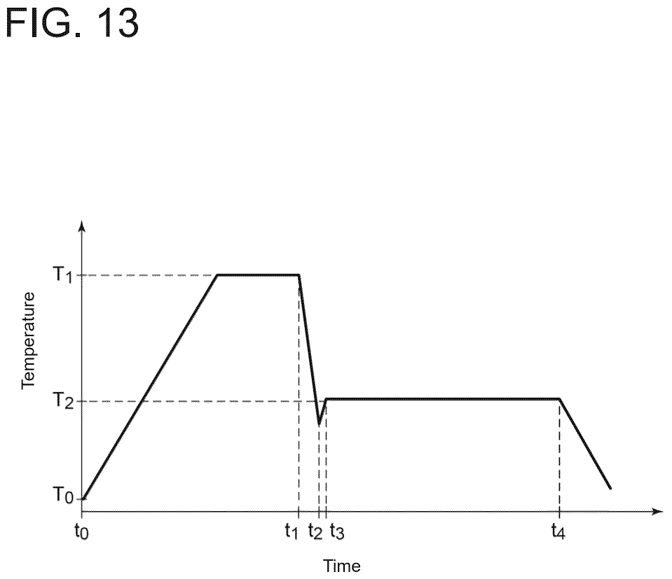

FIG. 13 is a graph showing an example of a time change in temperature of a specific portion of the metal strip S when the metal strip S is heat treated using a cooling method according to some embodiments.

As shown in FIG. 13, in some embodiments, at time t0, the metal strip S at a temperature T0 is heated in the first furnace and is increased to a temperature T1, and then maintained at the temperature T1 until time t1. Between the time t1 and time t2, the metal strip S is cooled to a temperature of about a temperature T2 by using the above-described cooling apparatus 1 (cooling step). Thereafter, the metal strip S is heated in the second furnace to maintain the temperature of the metal strip S at T2 between times t3 and t4.

The above-described temperature T1 may be a temperature of not lower than 600° C. Further, the above-described temperature T2 may be a temperature in a range of not lower than 100° C. and not higher than 400° C. That is, the above-described cooling step may include spraying the cooling medium from the nozzle 16 of the cooling apparatus 1 described above to the surface of the metal strip S of not lower than 600° C. to cool the metal strip S to the temperature range of not lower than 100° C. and not higher than 400° C. Also, after the cooling step, the temperature of the metal strip S may be maintained in the temperature range of not lower than 100° C. and not higher than 400° C.

The above-described heat treatment, that is, heat treatment in which the metal strip S is heated to the high temperature of not lower than 600° C. and then maintained at the temperature range of 100° C. to 400° C. after rapidly cooled to the above-described temperature range may be applied to a production process of an electrical steel sheet or high tensile steel.

In some embodiments, the above-described cooling step may include spraying the cooling medium to the surface of the metal strip S from the plurality of nozzles 16 such that a cooling speed of the metal strip S is not lower than 500° C. per second. Alternatively, the above-described cooling step may include spraying the cooling medium to the metal strip S such that the amount of the cooling medium sprayed to per square meter of the surface of the metal strip S is not less than 500 liters per minute. By using the above-described cooling apparatus 1 in the cooling step, the metal strip S can efficiently be cooled rapidly.

The contents described in the above embodiments would be understood as follows, for instance.

(1) A cooling apparatus (1) for a metal strip according to at least one embodiment of the present invention is a cooling apparatus for cooling a traveling metal strip(S), including: a plurality of nozzles (16) each configured to spray a cooling medium to a surface of the metal strip. A ratio La/Ln of a length La of an ineffective collision region (Rn) between a pair of effective collision regions adjacent in a traveling direction of the metal strip among effective collision regions (Re) of the plurality of nozzles in the traveling direction to a center-to-center distance Ln of the pair of effective collision regions in the traveling direction is at least 0.2 and at most 0.6. The effective collision regions are regions in which a collision density of a liquid on the surface of the metal strip is at least 50% of a maximum value, the liquid being contained in the cooling medium sprayed from the nozzles to the surface.

According to the above configuration (1), the cooling apparatus includes the plurality of nozzles, and the effective collision region of each of the plurality of nozzles is formed on the surface of the metal strip. Then, since the ratio La/Ln of the length La of the ineffective collision region between a pair of effective collision regions adjacent in the traveling direction of the metal strip in the traveling direction to the center-to-center distance Ln of the pair of effective collision regions is at least 0.2 and at most 0.6, the metal strip can efficiently be cooled. Reasons therefor are considered to be as follows.

That is, in the above configuration, since the above-described ratio La/Ln is at least 0.2, the dimension of the ineffective collision region formed between the effective collision regions in the traveling direction of the metal strip can be secured to some extent. Therefore, the liquid contained in the cooling medium jetted from the nozzles and colliding with the surface of the metal strip can leave the surface of the metal strip via the ineffective collision region without staying in the effective collision regions. Whereby, it is difficult to impede the supply of the cooling medium newly jetted from the nozzles to the surface of the metal strip, improving the cooling efficiency. Further, in the above configuration, since the above-described ratio La/Ln is at most 0.6, in the traveling direction of the metal strip, the ineffective collision region that does not contribute to cooling is not too wide. Therefore, the dimensions of the effective collision regions in the traveling direction of the metal strip can be maintained, improving the cooling efficiency. Thus, according to the above configuration (1), the metal strip can efficiently be cooled.

(2) In some embodiments, in the above configuration (1), the ratio La/Ln of the length La of the ineffective collision region in the traveling direction to the center-to-center distance Ln is at least 0.45 and at most 0.5.

According to the above configuration (2), since the above-described ratio is at least 0.45 and at most 0.5, the metal strip can more efficiently be cooled. That is, in the above configuration, since the above-described ratio La/Ln is at least 0.45, the greater dimension of the ineffective collision region formed between a pair of effective collision regions can be secured. Therefore, as described above, it is more difficult to impede the supply of the cooling medium newly jetted from the nozzles to the surface of the metal strip, further improving the cooling efficiency. Further, in the above configuration, since the above-described ratio La/Ln is at most 0.5, the ineffective collision region that does not contribute to cooling can be made narrower. Therefore, the effective collision regions can be made wider in the traveling direction of the metal strip, further improving the cooling efficiency. Thus, according to the above configuration (2), the metal strip can more efficiently be cooled.

(3) In some embodiments, in the above configuration (1) or (2), the length Le of each of the pair of effective collision regions in the traveling direction is not less than 80 mm and not greater than 140 mm.

In the above configuration (3), since the length Le of the effective collision region of the nozzle in the traveling direction of the metal strip is not less than 80 mm, it takes a certain amount of time for the metal strip to pass through the effective collision region. Therefore, while the metal strip passes through the effective collision region, a surface temperature of the metal strip is likely to enter a transition boiling region from a film boiling region. Thus, the metal strip can more efficiently be cooled. Further, in the above configuration (3), since the length Le of the effective collision region of the nozzle is not greater than 140 mm, a moving distance of a liquid film formed within the effective collision region to the ineffective collision region is relatively short. Therefore, the liquid film formed within the effective collision region easily flows out to the ineffective collision region, and can smoothly leave the surface of the metal strip via the ineffective collision region. Whereby, it is difficult to impede the supply of the cooling medium newly jetted from the nozzles to the surface of the metal strip, further improving the cooling efficiency. Thus, according to the above configuration (3), the metal strip can more efficiently be cooled.

(4) In some embodiments, in any one of the above configurations (1) to (3), the effective collision regions have a shape having a first axis (La) along a width direction of the metal strip and a second axis (Lb) intersecting the first axis, and the first axis is longer than the second axis.

According to the above configuration (4), since the effective collision regions have the shape having the first axis along the width direction of the metal strip and the second axis intersecting the first axis, and the first axis is longer than the second axis, the length of the effective collision regions in the traveling direction of the metal strip (the direction intersecting the width direction) is unlikely to become excessively long. Therefore, the liquid contained in the cooling medium sprayed from nozzles easily moves from the effective collision regions to the ineffective collision region and smoothly leaves the surface of the metal strip via the ineffective collision region without staying in the effective collision regions. Whereby, it is difficult to impede the supply of the cooling medium newly jetted from the nozzles to the surface of the metal strip, further improving the cooling efficiency. Thus, according to the above configuration (4), the metal strip can more efficiently be cooled.

(5) In some embodiments, in the above configuration (4), the first axis is inclined with respect to the width direction.

According to the above configuration (5), since the first axis is inclined with respect to the width direction of the metal strip, the proportion of a region in which the effective collision regions exist can be increased in the traveling direction of the metal strip compared to when the first axis is not inclined with respect to the width direction of the metal strip. Therefore, uneven cooling in the traveling direction of the metal strip can be suppressed, thereby facilitating the production of the metal strip of good quality.

(6) In some embodiments, in the above configuration (5), an angle (θ) of the first axis with respect to the width direction is not greater than 18 degrees.

According to the above configuration (6), since the angle of the first axis with respect to the width direction of the metal strip is not greater than 18 degrees, a timing at which the metal strip entering the effective collision regions is cooled does not vary significantly depending on the position in the width direction. Therefore, it is possible to reduce a difference in timing at which the surface temperature of the metal strip in the strip width direction reaches a transition boiling temperature. Therefore, uneven cooling in the width direction of the metal strip can be suppressed, thereby facilitating the production of the metal strip of good quality.

(7) In some embodiments, in the above configuration (6), the angle of the first axis with respect to the width direction is not less than 5 degrees and not greater than 15 degrees.

According to the above configuration (7), since the angle of the first axis with respect to the width direction of the metal strip is not less than 5 degrees and not greater than 15 degrees, it is possible to more effectively suppress uneven cooling in the traveling direction and the width direction of the metal strip. Therefore, it is easier to produce the metal strip of good quality.

(8) In some embodiments, in any of the above configurations (4) to (7), a contour (Re*) of the effective collision regions has a shape in which a pair of semicircular arcs are connected by two straight lines.

According to the above configuration (8), since the contour of the effective collision regions has the shape in which a pair of semicircular arcs are connected by the two straight lines, it is possible to widen a region in which an integrated value of a spray amount of the cooling medium over an entire length of the metal strip in the traveling direction is uniform in the width direction. Accordingly, it is possible to more effectively reduce uneven cooling in the width direction of the metal strip.

(9) A heat treatment facility (100) for a metal strip according to at least one embodiment of the present invention, includes: a furnace for heat treating the metal strip; and the cooling apparatus (1) as defined in any one of the above (1) to (8), configured to cool the metal strip heat treated in the furnace.

According to the above configuration (9), the cooling apparatus includes a plurality of nozzles, and the effective collision region of each of the plurality of nozzles is formed on the surface of the metal strip. Then, since the ratio La/Ln of the length La of the ineffective collision region between a pair of effective collision regions adjacent in the traveling direction of the metal strip in the traveling direction to the center-to-center distance Ln of the pair of effective collision regions is at least 0.2 and at most 0.6, the metal strip can efficiently be cooled. Reasons therefor are considered to be as follows.

That is, in the above configuration, since the above-described ratio La/Ln is at least 0.2, the dimension of the ineffective collision region formed between the effective collision regions in the traveling direction of the metal strip can be secured to some extent. Therefore, the liquid contained in the cooling medium jetted from the nozzles and colliding with the surface of the metal strip can leave the surface of the metal strip via the ineffective collision region without staying in the effective collision regions. Whereby, it is difficult to impede the supply of the cooling medium newly jetted from the nozzles to the surface of the metal strip, improving the cooling efficiency. Further, in the above configuration, since the above-described ratio La/Ln is at most 0.6, in the traveling direction of the metal strip, the ineffective collision region that does not contribute to cooling is not too wide. Therefore, the dimensions of the effective collision regions in the traveling direction of the metal strip can be maintained, improving the cooling efficiency. Thus, according to the above configuration (9), the metal strip can efficiently be cooled.

(10) A cooling method for a metal strip according to at least one embodiment of the present invention is a cooling method for cooling a traveling metal strip (S) by using a cooling apparatus (1) including a plurality of nozzles (16), including: a step of cooling the metal strip by spraying a cooling medium to a surface of the metal strip from the plurality of nozzles. The step of cooling includes spraying the cooling medium to the surface of the metal strip such that a ratio La/Ln of a length La of an ineffective collision region between a pair of effective collision regions adjacent in a traveling direction of the metal strip among effective collision regions of the plurality of nozzles in the traveling direction to a center-to-center distance Ln of the pair of effective collision regions in the traveling direction is at least 0.2 and at most 0.6. The effective collision regions are regions in which a collision density of a liquid on the surface of the metal strip is at least 50% of a maximum value, the liquid being contained in the cooling medium sprayed from the nozzles to the surface.

According to the above method (10), the cooling apparatus includes the plurality of nozzles, and the effective collision region of each of the plurality of nozzles is formed on the surface of the metal strip. Then, since the ratio La/Ln of the length La of the ineffective collision region between a pair of effective collision regions adjacent in the traveling direction of the metal strip in the traveling direction to the center-to-center distance Ln of the pair of effective collision regions is at least 0.2 and at most 0.6, the metal strip can efficiently be cooled. Reasons therefor are considered to be as follows.

That is, in the above configuration, since the above-described ratio La/Ln is at least 0.2, the dimension of the ineffective collision region formed between the effective collision regions in the traveling direction of the metal strip can be secured to some extent. Therefore, the liquid contained in the cooling medium jetted from the nozzles and colliding with the surface of the metal strip can leave the surface of the metal strip via the ineffective collision region without staying in the effective collision regions. Whereby, it is difficult to impede the supply of the cooling medium newly jetted from the nozzles to the surface of the metal strip, improving the cooling efficiency. Further, in the above configuration, since the above-described ratio La/Ln is at most 0.6, in the traveling direction of the metal strip, the ineffective collision region that does not contribute to cooling is not too wide. Therefore, the dimensions of the effective collision regions in the traveling direction of the metal strip can be maintained, improving the cooling efficiency. Thus, according to the above method (10), the metal strip can efficiently be cooled.

(11) In some embodiments, in the above method (10), the step of cooling includes spraying the cooling medium to the surface of the metal strip from the plurality of nozzles such that an amount of the cooling medium sprayed to per square meter of the surface of the metal strip is not less than 500 liters per minute.

According to the above method (11), since the cooling medium is sprayed to the metal strip such that the amount of the cooling medium sprayed to per square meter of the surface of the metal strip is not less than 500 liters per minute, the metal strip can efficiently be cooled in such a case where the metal strip is rapidly cooled.

(12) In some embodiments, in the above method (10) or (11), the step of cooling includes spraying the cooling medium to the surface of the metal strip of not lower than 600° C. to cool the metal strip to a temperature range of not lower than 100° C. and not higher than 400° C.

According to the above method (12), the cooling medium is sprayed to the metal strip of not lower than 600° C. to cool the metal strip to a temperature range of not lower than 100° C. and not higher than 400° C. Thus, in the case where the metal strip is cooled in this temperature range, the metal strip can efficiently be cooled.

(13) In some embodiments, in any of the above methods (10) to (12), the step of cooling includes spraying the cooling medium to the surface of the metal strip such that a length Le of the effective collision regions in the traveling direction is not less than 80 mm and less than 140 mm.

In the above method (13), since the length Le of the effective collision region of the nozzles in the traveling direction of the metal strip is not less than 80 mm, it takes a certain amount of time for the metal strip to pass through the effective collision regions. Therefore, while the metal strip passes through the effective collision regions, a surface temperature of the metal strip is likely to enter a transition boiling region from a film boiling region. Thus, the metal strip can more efficiently be cooled. Further, in the above method (13), since the length Le of the effective collision regions of the nozzles is not greater than 140 mm, a moving distance of a liquid film formed within the effective collision regions to the ineffective collision region is relatively short. Therefore, the liquid film formed within the effective collision regions easily flows out to the ineffective collision region, and can smoothly leave the surface of the metal strip via the ineffective collision region. Whereby, it is difficult to impede the supply of the cooling medium newly jetted from the nozzles to the surface of the metal strip, further improving the cooling efficiency. Thus, according to the above method (13), the metal strip can more efficiently be cooled.

(14) In some embodiments, in any of the above methods (10) to (13), the step of cooling includes spraying the cooling medium to the surface of the metal strip such that the effective collision regions have a shape which has a first axis (La) along a width direction of the metal strip and a second axis (Lb) orthogonal to the first axis, and in which the first axis is longer than the second axis.

According to the above method (14), since the effective collision regions have the shape having the first axis along the width direction of the metal strip and the second axis intersecting the first axis, and the first axis is longer than the second axis, the length of the effective collision region in the traveling direction of the metal strip (the direction intersecting the width direction) is unlikely to become excessively long. Therefore, the liquid contained in the cooling medium sprayed from nozzles easily moves from the effective collision regions to the ineffective collision region and smoothly leaves the surface of the metal strip via the ineffective collision region without staying in the effective collision regions. Whereby, it is difficult to impede the supply of the cooling medium newly jetted from the nozzles to the surface of the metal strip, further improving the cooling efficiency. Thus, according to the above method (14), the metal strip can more efficiently be cooled.

(15) In some embodiments, in the above method (14), the step of cooling includes spraying the cooling medium to the surface of the metal strip in a state in which the first axis is inclined with respect to the width direction.

According to the above method (15), since the first axis is inclined with respect to the width direction of the metal strip, the proportion of a region in which the effective collision regions exist can be increased in the traveling direction of the metal strip compared to when the first axis is not inclined with respect to the width direction of the metal strip. Therefore, uneven cooling in the traveling direction of the metal strip can be suppressed, thereby facilitating the production of the metal strip of good quality.

(16) In some embodiments, in the above method (14) or (15), the step of cooling includes spraying the cooling medium to the surface of the metal strip such that a contour of the effective collision regions has a shape in which a pair of semicircular arcs are connected by two straight lines.

According to the above method (16), since the contour of the effective collision regions has the shape in which a pair of semicircular arcs are connected by the two straight lines, it is possible to widen a region in which an integrated value of a spray amount of the cooling medium over an entire length of the metal strip in the traveling direction is uniform in the width direction. Accordingly, it is possible to more effectively reduce uneven cooling in the width direction of the metal strip.

Embodiments of the present invention were described in detail above, but the present invention is not limited thereto, and also includes an embodiment obtained by modifying the above-described embodiments and an embodiment obtained by combining these embodiments as appropriate.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, an expression of a shape such as a rectangular shape or a cylindrical shape shall not be construed as only the geometrically strict shape, but also includes a shape with unevenness or chamfered corners within the range in which the same effect can be achieved.

Furthermore, in the present specification, the expressions “comprising”, “including” or “having” one constitutional element is not an exclusive expression that excludes the presence of other constitutional elements.

### REFERENCE SIGNS LIST

1 Cooling apparatus
6 Roll
8 Guide roll
10 Jet unit
12 Header portion
14 Nozzle row
16, 16A to 16C Nozzle
17 Cooling medium
100 Heat treatment facility
A (A1 to A5) End point
B (B1 to B5) End point
La First axis
Lb Second axis
Ln Center-to-center distance
R0 Collision region
Re Effective collision region
Re* Contour
Rn Ineffective collision region
S Metal strip

1. A cooling apparatus for cooling a traveling metal strip, comprising:
a plurality of nozzles each configured to spray a cooling medium to a surface of the metal strip,
wherein a ratio La/Ln of a length La of an ineffective collision region between a pair of effective collision regions adjacent in a traveling direction of the metal strip among effective collision regions of the plurality of nozzles in the traveling direction to a center-to-center distance Ln of the pair of effective collision regions in the traveling direction is at least 0.2 and at most 0.6, and
wherein the effective collision regions are regions in which a collision density of a liquid on the surface of the metal strip is at least 50% of a maximum value, the liquid being contained in the cooling medium sprayed from the nozzles to the surface.

2. The cooling apparatus for the metal strip according to claim 1,
wherein the ratio La/Ln of the length La of the ineffective collision region in the traveling direction to the center-to-center distance Ln is at least 0.45 and at most 0.5.

3. The cooling apparatus for the metal strip according to claim 1,
wherein the length Le of each of the pair of effective collision regions in the traveling direction is not less than 80 mm and not greater than 140 mm.

4. The cooling apparatus for the metal strip according to claim 1,
wherein the effective collision regions have a shape having a first axis along a width direction of the metal strip and a second axis intersecting the first axis, and
wherein the first axis is longer than the second axis.

5. The cooling apparatus for the metal strip according to claim 4,
wherein the first axis is inclined with respect to the width direction.

6. The cooling apparatus for the metal strip according to claim 5,
wherein an angle of the first axis with respect to the width direction is not greater than 18 degrees.

7. The cooling apparatus for the metal strip according to claim 6,
wherein the angle of the first axis with respect to the width direction is not less than 5 degrees and not greater than 15 degrees.

8. The cooling apparatus for the metal strip according to claim 4,
wherein a contour of the effective collision regions has a shape in which a pair of semicircular arcs are connected by two straight lines.

9. A heat treatment facility for a metal strip, comprising:
a furnace for heat treating the metal strip; and
the cooling apparatus according to claim 1, configured to cool the metal strip heat treated in the furnace.

10. A cooling method for cooling a traveling metal strip by using a cooling apparatus including a plurality of nozzles, comprising:
a step of cooling the metal strip by spraying a cooling medium to a surface of the metal strip from the plurality of nozzles,
wherein the step of cooling includes spraying the cooling medium to the surface of the metal strip such that a ratio La/Ln of a length La of an ineffective collision region between a pair of effective collision regions adjacent in a traveling direction of the metal strip among effective collision regions of the plurality of nozzles in the traveling direction to a center-to-center distance Ln of the pair of effective collision regions in the traveling direction is at least 0.2 and at most 0.6, and
wherein the effective collision regions are regions in which a collision density of a liquid on the surface of the metal strip is at least 50% of a maximum value, the liquid being contained in the cooling medium sprayed from the nozzles to the surface.

11. The cooling method for the metal strip according to claim 10,
wherein the step of cooling includes spraying the cooling medium to the surface of the metal strip from the plurality of nozzles such that an amount of the cooling medium sprayed to per square meter of the surface of the metal strip is not less than 500 liters per minute.

12. The cooling method for the metal strip according to claim 10,
wherein the step of cooling includes spraying the cooling medium to the surface of the metal strip of not lower than 600° C. to cool the metal strip to a temperature range of not lower than 100° C. and not higher than 400° C.

13. The cooling method for the metal strip according to claim 10,
wherein the step of cooling includes spraying the cooling medium to the surface of the metal strip such that a length Le of the effective collision regions in the traveling direction is not less than 80 mm and less than 140 mm.

14. The cooling method for the metal strip according to claim 10,
wherein the step of cooling includes spraying the liquid to the surface of the metal strip such that the effective collision regions have a shape which has a first axis along a width direction of the metal strip and a second axis orthogonal to the first axis, and in which the first axis is longer than the second axis.

15. The cooling method for the metal strip according to claim 14,
wherein the step of cooling includes spraying the cooling medium to the surface of the metal strip in a state in which the first axis is inclined with respect to the width direction.
